(19) United States
(12) Patent Application Publication
(10) Pub. No.: US 2016/0097315 A1
(43) Pub. Date: Apr. 7, 2016

(54) SILENCER

(71) Applicant: GM GLOBAL TECHNOLOGY OPERATIONS LLC, Detroit, MI (US)

(72) Inventors: Kai BECKER, Oftersheim (DE); Ralf SIBER, Mainz (DE)

(73) Assignee: GM GLOBAL TECHNOLOGY OPERATIONS LLC, Detroit, MI (US)

(21) Appl. No.: 14/872,649

(22) Filed: Oct. 1, 2015

(30) Foreign Application Priority Data
Oct. 1, 2014 (DE) 202014007986.2

(51) Int. Cl. F01N 13/18; F01N 1/02; F24F 13/24; F02M 35/12

(52) U.S. Cl. CPC F01N 13/18; F02M 35/1266; F02M 35/1216; F01N 1/026; F24F 13/24

(57) ABSTRACT

A silencer for a motor vehicle and in particular air intake or exhaust gas lines and/or HVAC air passageways is disclosed. The silencer includes a pipe arranged in a housing, which defines a duct and an annular orifice arrangement having a first annular orifice which extends from the pipe to the housing. The housing and pipe form a chamber arrangement with a first chamber and a second chamber, which are separated by the first annular orifice and communicate with the duct through apertures in the pipe. The housing is designed integrally with a first connector and the pipe integrally with a second connector, which communicate with the duct, and in particular merge into the duct.

### CROSS-REFERENCE TO RELATED APPLICATION

This application claims priority to German Patent Application No. 202014007986,2, filed Oct. 1, 2014, which is incorporated herein by reference in its entirety.

### TECHNICAL FIELD

The present disclosure pertains to a silencer, in particular for a motor vehicle, to a kit for the optional production of different silencers, and to a motor vehicle, in particular a passenger car with a silencer.

### BACKGROUND

DE 43 2 562 A1 discloses a silencer with resonator chambers with parallel walls, which are connected to a conical pipe by welding and are embraced by a cylindrical covering band. As further provided herein, the silencer disclosed therein may be the subject of certain improvements in the production, assembly and/or characteristics thereof.

### SUMMARY

The present disclosure provides a silencer including a housing, a pipe arranged in the housing, which defines a duct, and a annular orifice arrangement with a first annular orifice, which extends from the pipe to the housing. The housing and pipe form a chamber arrangement with a first and a second chamber, which are separated by the first annular orifice and communicate with the duct through apertures in the pipe. The housing is preferably a unitary housing integrally formed, in particular by casting, with a connector such as a unitary pipe integrally formed with a second connector, which in each case communicate with the duct, and in particular merge into the duct. Because of this, a silencer, in an embodiment, can be advantageously produced with fewer individual parts, which can be advantageously assembled, in particular connected to a line via its connectors.

In an embodiment, the housing includes a wall adjacent to the first connector with a bore. The pipe axially stands against this wall and/or engages in the bore, in particular engages through the same. Because of this, the duct, in an embodiment, can advantageously communicate with the first communicator in particular merge into the same.

In an embodiment, the first connector and/or the second connector have a smaller outer diameter than the housing. Because of this, compact connections, in an embodiment, can be advantageously combined with a larger chamber arrangement.

In an embodiment, the chamber arrangement includes a third chamber which is axially delimited by a second and third annular orifice of the annular orifice arrangement and communicates with the duct through apertures in the pipe. In a further development, the chamber arrangement includes three chambers. Here, one chamber, in an embodiment, can be advantageously designed or equipped as high pass, one chamber as band pass, and one chamber as low pass. In another further development, the chamber arrangement includes more than three chambers, which are delimited analogously by further annular orifices of the annular orifice arrangement and communicate with the duct through apertures in the pipe. In an embodiment, one or multiple, in particular all chambers except for the apertures in the pipe are closed, in particular air-tight.

In an embodiment, one or multiple annular orifices of the annular orifice arrangement in particular the ones that are nearer the first connector are connected to the housing in a frictionally joined and/or sealing, in particular air-tight manner. For example, the orifices are elastically radially clamped to or against the housing. To this end, these annular orifices in an embodiment form a press or oversize fit with the housing. In an embodiment, these annular orifices, in particular together with the pipe, are introduced into the housing which can improve the production of the silencer.

Additionally or alternatively, one or multiple orifices of the annular orifice arrangement are connected to the housing in a materially joined manner, in particular glued or welded, in particular friction welded together. In particular, an annular orifice of the annular orifice arrangement that is next to the second connector can be connected to a face end of the housing in such a manner. Because of this, the production of the silencer, in an embodiment, can be improved; in particular the annular orifice axially supports itself on the housing.

In an embodiment, one or multiple orifices of the annular orifice arrangement are integrally formed with the pipe, in particular injection-molded. In addition or alternatively, one or multiple orifices of the annular orifice arrangement, in an embodiment, are connected to the pipe in a materially joined manner, in particular glued or welded together, in particular friction-welded. In a further development, the pipe or the second connector that is integrally formed therewith includes a radial flange which an annular orifice of the annular orifice arrangement abuts. Because of this, the production of the silencer, in an embodiment, can be improved, in particular the annular orifice axially support itself on the pipe or radial flange.

In an embodiment, the pipe diverges in axial direction, in particular in the through-flow direction, at least in sections, in particular at least substantially over its axial length. In an embodiment, the diverging pipe includes a radially outer lateral surface forming the chamber arrangement which diverges in axial direction at least in sections and/or a radially inner lateral surface forming the duct which diverges in axial direction at least in sections, in particular parallel to the outer lateral surface forming the duct. Accordingly, the pipe in an embodiment includes at least substantially a constant wall thickness. In an embodiment, the pipe diverges, in particular its radially outer and/or inner lateral surface in axial, in particular through-flow direction monotonously, in particular strictly monotonously, in particular linearly. Because of this, the production and/or through-flow in an embodiment can be improved.

In an embodiment, the portion of the pipe has a substantially conical cross section. Additionally or alternatively, the housing, in an embodiment, includes a radially inner lateral surface forming the chamber arrangement that is in particular parallel to an outer lateral surface which, at least substantially, is cylindrical, in particular circular-cylindrical.

In an embodiment, housing, pipe and/or annular orifice arrangement include fiber-reinforced plastic, in particular thermoplastic, and more particularly e.g., polyoxymethylene (POM), polyethylene (PE), polypropylene (PP), polyamide (PA), polyethylene terephthalate (PET), polybutylene terephthalate (PBT), acrylonitrile-butadiene-styrene (ABS), polymethylmethacrylate (PMMA), polystyrene (PS), polyvinylchloride (PVC), polycarbonate (PC), styrene-acrylonitrile-copolymer (SAN) and/or polyphenylene ether (PPE).

In an embodiment, the chamber which is upstream in through-flow direction has a greater volume with one or multiple, in particular all pairs of adjacent chambers of the chamber arrangement than the downstream chamber. Because of this, higher frequencies can be advantageously dampened upstream in an embodiment. Additionally or alternatively, higher flow velocities, in an embodiment, can be imparted to the larger volumes, in an embodiment, because of the diverging pipe.

In an embodiment, one or multiple chambers of the chamber arrangement are designed as absorption, reflection and/or resonance, in particular Helmholtz silencers. Through calculation and/or tests, the person skilled in the art can determine suitable dimensions, in particular wall thicknesses, volumes and/or aperture geometries, and/or surface areas. In an embodiment, the chambers, in particular the housing the pipe and/or the annular orifice, have a wall thickness that is between 0.5 min and 5 mm, and preferably between 1 mm and 3 mm.

In an embodiment, the first connector is a plug-in connector, which is equipped for plugging-in a line, in particular a connection coupling or a hose, in particular a so-called VDA connector, or a plug-on connector, which is equipped for plugging on a line, in particular a connection coupling or a hose, in particular includes corrugations and/or an undercut for securing a hose elastically plugged on.

Additionally or alternatively, the second connector, in an embodiment, is a plug-on connector, which is equipped for plugging on a line, in particular a connection coupling or a hose, in particular includes corrugations and/or an undercut for securing an elastically plugged-on hose, or a plug-in connector, which is equipped for plugging-in a line, in particular a connection coupling or a hose, in particular a so-called VDA connector. In an embodiment, the first and/or the second connector includes a retaining clip and/or a seal.

According to an aspect of the present disclosure, a silencer described here is produced in modular form, in that a housing is optionally connected to one of multiple different pipes, which differ in annular orifice arrangements which are connected to these or integrally formed, and/or apertures, through which the chamber arrangement communicates with the duct. In this way, optionally different silencers, in an embodiment, can be advantageously produced with few components, in particular the chambers and/or their couplings to the duct be matched to different frequencies. Accordingly, a kit, according to an aspect of the present disclosure, includes a housing and at least two different pipes with different annular orifice arrangements and/or apertures for the optional production of a first silencer described here or of a second silencer described here, which differs from the first silencer, in particular in chamber volumes of the chamber arrangement and/or number, size and/or distribution of the apertures.

A silencer described here is used in an embodiment for silencing gas flow (i.e., attenuating noise) in a conduit of a motor vehicle, an air intake or exhaust gas line of an internal combustion engine or an air passageway of an air-conditioning system of the motor vehicle. Accordingly, a motor vehicle, in particular a passenger car, includes a silencer described here according to an aspect of the present disclosure, which in a further development, is connected, in particular detachably or non-detachably to a conduit, in particular intake or exhaust gas line of an internal combustion engine or an air passageway of an air-conditioning system of the motor vehicle. A further aspect of the present disclosure concerns the production of a silencer described here, in particular the connecting of the pipe to the housing.

### BRIEF DESCRIPTION OF THE DRAWINGS

The present disclosure will hereinafter be described in conjunction with the following drawing figures, wherein like numerals denote like elements.

FIG. 1 shows an axial section of a silencer according to an embodiment of the present disclosure;

FIG. 2 shows a housing and a pipe of the silencer spaced from one another; and

FIG. 3 is a perspective outside view of the silencer with a spaced retaining clip.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

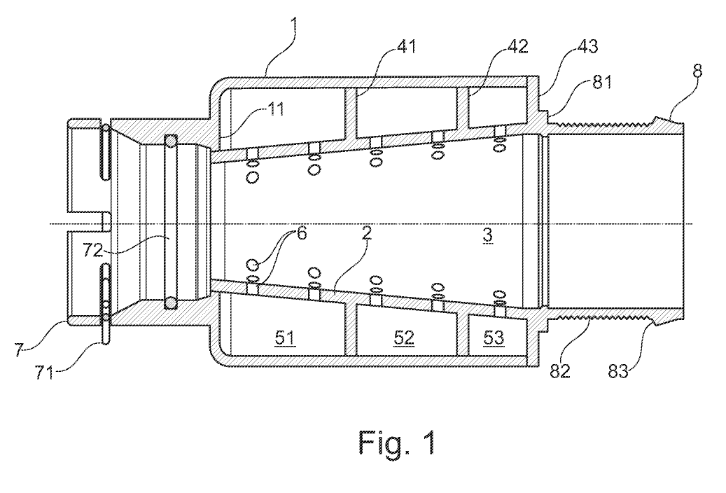

FIG. 1 shows an axial section of a silencer according to an embodiment of the present disclosure. The silencer includes a housing 1, a pipe 2 arranged in the housing 1, which defines a duct 3, and an annular orifice arrangement with a first annular orifice 41, which extends from the pipe 2 to the housing 1. The housing 1 and pipe 2 form a chamber arrangement with a first chamber 51 and a second chamber 52, which are separated by the first annular orifice 41 and communicate with the duct 3 through apertures 6 in the pipe 2. The unitary housing 1 are integrally cast with a first connector 7 and the unitary pipe 2 is integrally cast with a second connector 8, each of which merges into the duct 3. The housing 1 has a wall 11 adjacent to the first connector 7 with a bore, wherein the pipe 2 engages in the bore. The first connector 7 and the second connector 8 have a smaller outer diameter than the housing 1.

The chamber arrangement includes a third chamber 53, which is axially delimited by a second and third annular orifice 42, 43 of the annular orifice arrangement and communicates with the duct 3 through apertures 6 in the pipe 2. In the exemplary embodiment, the chamber arrangement includes the three chambers 51-53. Here, the first chamber 51 is designed as high pass, the second chamber 52 as band pass and the third chamber 53 as low pass.

The first and second annular orifices 41, 42 nearer the first connector 7 form a press or oversize fit with the housing 1 and are thereby elastically radially clamped to or against the housing 1, so that they are connected to the housing 1 in a frictionally joined and sealing manner. The third annular orifice 43 of the annular orifice arrangement that is next to the second connector 8 is friction-welded to a face end of the housing 1.

The second connector 8 which is integrally formed with the pipe 2 includes a radial flange 81, which the third annular orifice 43 abuts. The annular orifices 41-43 can be designed integrally with the pipe 2 or be connected to the same in a materially joined manner. The pipe 2 is conical, so that it diverges in through-flow direction (from left to right in FIG. 1) over its axial length. The housing 1 is circular-cylindrical. Housing 1, pipe 2 and annular orifice arrangement 41-43 includes plastic.

With both pairs (51, 52) and (52, 53) adjacent chambers of the chamber arrangement, the chambers 51, 52 located upstream in through-flow direction (left in FIG. 1) has a larger volume than the chamber 52, 53 (right in FIG. 1) located downstream.

The first connector 7 is a plug-in connector, which is equipped for plugging in a line (not shown), in particular a so-called VDA connector. The second connector 8 is a plug-on connector, which is equipped for plugging on a line (not shown) and for this purpose has corrugations 82 and an undercut 83 for securing an elastically plugged-on hose. The first connector 7 includes a retaining clip 71 and a seal 72.

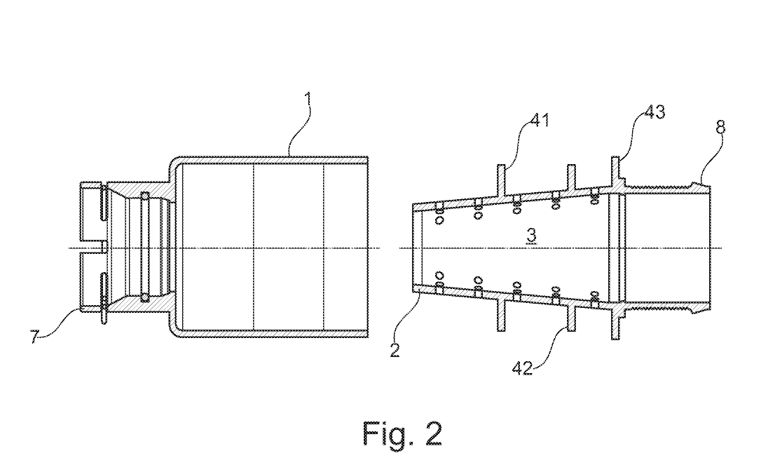

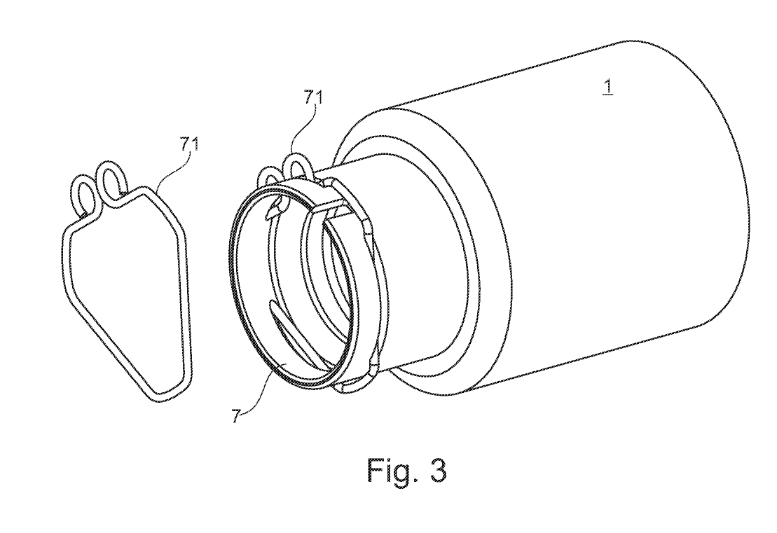

The silencer is produced in modular form in that the housing 1 is optionally connected to one of multiple different pipes 2, which differ in annular orifice arrangements 41-43 connected to them or integrally formed with them, and/or apertures 6, through which the chamber arrangement 51-53 communicates with the duct 3. To this end, FIG. 2 shows the housing 1 and the pipe 2 with the annular orifice arrangements 41-43 spaced from one another. The pipe 2 and the annular orifice arrangement 41-43 connected with it or integrally formed is, as indicated by the figure sequence FIG. 2→FIG. 1., pushed into the housing 1, as a result of which the annular orifices 41, 42 are connected to the housing 1 in a frictionally-joined and sealing manner and the pipe 2 is plugged into the bore of the wall 11. Following this, the third annular orifice 43 is friction-welded to the in FIG. 1, 2 right face end of the housing. To illustrate, FIG. 3 shows a perspective outside view of the silencer with a retaining clip 71 in an installed state spaced from the first connector.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-12. (canceled)

13. A silencer for a motor vehicle comprising:
a pipe arranged in a housing defining a duct and forming a chamber arrangement with a first chamber and a second chamber; and
an annular orifice arrangement having a first annular orifice which extends from the pipe to the housing, wherein the annular orifice arrangement separates by the first and second chambers and communicates with the duct through apertures in the pipe;
wherein the housing is configured integrally with a first connector and the pipe is configured integrally with a second connector communicating with the duct.

14. The silencer according to claim 13, wherein the pipe merges into the duct.

15. The silencer according to claim 13, wherein the chamber arrangement comprises a third chamber, which is axially delimited by a second and third annular orifice of the annular orifice arrangement and communicates with the duct through apertures in the pipe.

16. The silencer according to claim 13, wherein at least one annular orifice of the annular orifice arrangement is connected to the housing in at least one of a sealing manner and a frictionally joined manner.

17. The silencer according to claim 13, wherein at least one annular orifice of the annular orifice arrangement is connected to the housing in a materially joined manner.

18. The silencer according to claim 13, wherein an annular orifice of the annular orifice arrangement is connected to a face end of the housing in a materially joined manner, in particular through friction welding.

19. The silencer according to claim 18, wherein an annular orifice of the annular orifice arrangement is connected to a face end of the housing through friction welding.

20. The silencer according to claim 13, wherein the pipe is connected to at least one annular orifice of the annular orifice arrangement in a materially joined manner.

21. The silencer according to claim 20, wherein the pipe is formed integrally to the at least one annular orifice of the annular orifice arrangement.

22. The silencer according to claim 13, wherein he pipe diverges in axial direction.

23. The silencer according to claim 13, further comprising at least one pair of adjacent chambers including a first chamber and a second chamber downstream in through-flow direction of the first chamber, wherein the first chamber has a volume that is larger than the second chamber.

24. The silencer according to claim 13, wherein the first connector and the second connector each comprise one of a plug-in connector or a plug-on connector.

25. The silencer according to claim 13, wherein at least one of the first and second connectors comprise a retaining clip and a seal.

26. A silencer kit comprising a housing and at least two pipes, each pipe having at least one of a different orifice arrangement or a different aperture arrangement such that a first silence or second silencer can be assembled according to claim 13.

27. A motor vehicle comprising a conduit configured to transport a gas and a silencer according to claim 13 in fluid communication with the conduit.
